(19) United States
(12) Patent Application Publication
(10) Pub. No.: US 2025/0335777 A1
(43) Pub. Date: Oct. 30, 2025

(54) SUPERVISED FINE-TUNING OF LARGE LANGUAGE MODELS

(71) Applicant: Zoom Video Communications, Inc., San Jose, CA (US)

(72) Inventors: Ravi Agrawal, San Francisco, CA (US); Xuedong David Huang, Yarrow Point, WA (US); Wenxuan Zhou, Los Angeles, CA (US); Chenguang Zhu, Issaquah, WA (US)

(73) Assignee: Zoom Video Communications, Inc., San Jose, CA (US)

(21) Appl. No.: 18/650,764

(22) Filed: Apr. 30, 2024

(51) Int. Cl. G06N 3/091

(52) U.S. Cl. CPC G06N 3/091

(57) ABSTRACT

Example systems and methods for fine-tuning a pre-trained large language model are provided. In one example, a communication platform accesses a fine-tuning input in a target language for the pre-trained LLM. The communication platform obtains labeled data based on the fine-tuning input as a fine-tuning output. The communication platform obtains a fine-tuning input in a reference language corresponding to the fine-tuning input in the target language. The communication platform fine-tunes the pre-trained LLM for a generative task based on the fine-tuning input in the target language, the fine-tuning input in the reference language, and the fine-tuning output to obtain a first fine-tuned LLM.

### FIELD

The present application generally relates to large language models (LLMs) and more specifically relates to supervised fine-tuning of LLMs.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 shows an example system that provides chat and videoconferencing functionalities to various client devices;

FIG. 2 shows an example system in which a chat and video conference provider provides chat and videoconferencing functionalities to various client devices;

FIG. 3 shows an example system for establishing a virtual communication session;

FIG. 4 shows an example system that is configured to fine-tune an LLM;

FIG. 5 shows an example diagram of fine-tuning a pre-trained LLM;

FIG. 6 shows another example diagram of fine-tuning a pre-trained LLM;

FIG. 7 shows an example process for fine-tuning a pre-trained LLM;

FIG. 8 shows another example process for fine-tuning a pre-trained LLM;

FIG. 9 shows an example process for generating an output using a fine-tuned LLM in FIG. 7;

FIG. 10 shows an example process for generating an output using a fine-tuned LLM in FIG. 8; and

FIG. 11 shows an example computing device suitable for use with example systems and methods for fine-tuning an LLM or using a fine-tuned LLM to generate an output according to this disclosure.

### DETAILED DESCRIPTION

Examples are described herein in the context of supervised fine-tuning of LLMs. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application-and business-related constraints, and that these specific goals will vary from one implementation to another and from one developer to another.

A large set of large language models (LLMs) are available in industrial and scientific fields. Each LLM has its peculiarities that can be related to its architecture, the training procedure, the training data, etc. In general, there is a lack of annotated datasets in non-English languages, which can be called low-resource languages. Thus, multilingual capabilities of an LLM may need improvement. An LLM can be retrained as more annotated datasets in different language become available. However, collecting multilingual datasets for training can be expensive, and retraining an LLM may incur a large amount of cost, based on the size of the training datasets, the duration of the training process, and the compute resource need for training. Another way to get better results in a non-English language is to first use a translation model at the input to translate an input in a low-resource language to an English input. The English input is then provided to an LLM to generate an English output. The English output is then translated to the low-resource language. Two translation steps are involved, increasing the risk of system level translation error.

To improve an LLM's multilingual capability at a fraction of the cost for retraining, it is desirable for a communication platform to fine-tune an LLM in a certain language as needed with a much-smaller dataset. For example, the communication platform provides a fine-tuner engine for fine-tuning an LLM's performance in a non-English language.

In an example, a user selects a pre-trained LLM for performing certain generative tasks in Italian. The fine-tuner engine can fine-tune the pre-trained LLM first. The fine-tuner engine receives an Italian fine-tuning input, for example a meeting transcript in Italian. The fine-tuner engine also receives an English fine-tuning input corresponding to the Italian fine-tuning input. The English fine-tuning input can be translated from the Italian fine-tuning input by a translation model.

Meanwhile, the fine-tuner engine also receives labeled data based on the Italian fine-tuning input, which can be used as ground truth fine-tuning output. The labeled data can be obtained via human annotations. Alternatively, the communication platform can implement a generative model to generate human-quality labels in the Italian input to obtain the labeled data.

In some examples, the fine-tuner engine fine-tunes the pre-trained LLM by using joint input data. For example, the Italian fine-tuning input and the English fine-tuning input are provided to the pre-trained LLM to generate an interim Italian output. The fine-tuner engine then minimizes a cross-entropy loss function associated with the interim Italian output and the ground truth fine-tuning output by adjusting or optimizing certain weights used in the pre-trained LLM. The fine-tuner engine then updates these weights in the pre-trained LLM with the optimized weights to provide a fine-tuned LLM.

Alternatively, or additionally, the fine-tuner engine fine-tunes the pre-trained LLM by using joint output data. For example, the fine-tuner engine uses a frozen model to obtain an Italian output based on the Italian input, and obtains an English output based on the English input. The frozen model can be an ML model that does not change or evolve during implementation. Certain freezing techniques can be applied to an ML model to prevent weights in a ML model from being modified during an inference stage. The frozen model can be the pre-trained LLM or another LLM that performs better in Italian and English than the pre-trained LLM does. The fine-tuner engine then uses the pre-trained LLM to generate an interim Italian output based on the English fine-tuning input, the Italian output generated by the frozen model, and the English output generated by the frozen model. The fine-tuner engine minimizes a cross-entropy loss function associated with the interim Italian output and the ground truth fine-tuning output by adjusting or optimizing certain weights used in the pre-trained LLM. The fine-tuner engine then updates these weights in the pre-trained LLM with the optimized weights to provide a fine-tuned LLM.

The fine-tuned LLM can be used for certain generative tasks in Italian, with improved performance compared to the pre-trained LLM prior to fine-tuning. Thus, with these example fine-tuning techniques, a pre-trained LLM's performance in certain language can be improved with a fraction of cost incurred by retraining the LLM. Meanwhile, compared to using a translation model at the input and a translation model at the output, the fine-tuning techniques only involves one translation model, and the risk of system level translation error is also reduced.

This illustrative example is given to introduce the reader to the general subject matter discussed herein and the disclosure is not limited to this example. The following sections describe various additional non-limiting examples and examples of fine-tuning large language models.

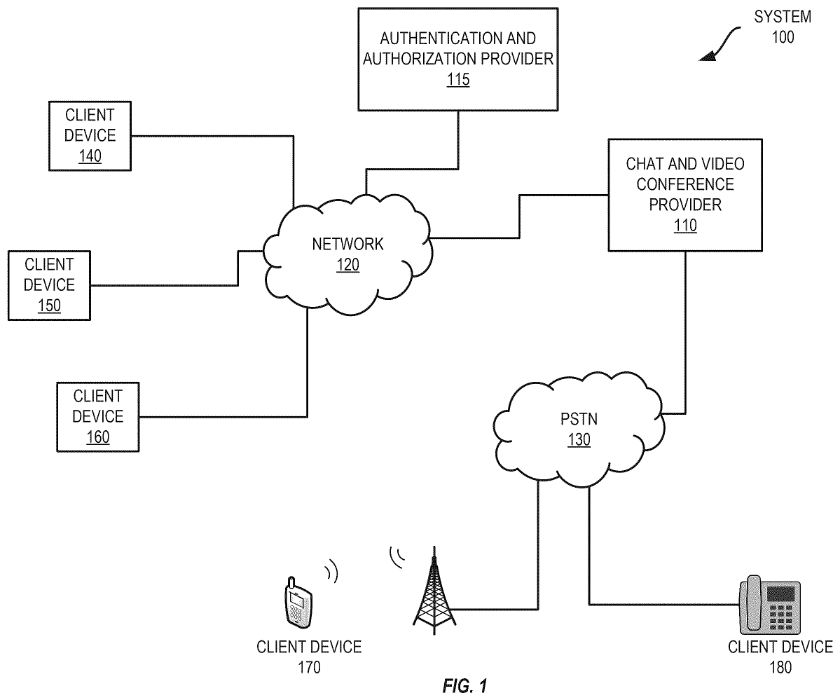

Referring now to FIG. 1, FIG. 1 shows an example system 100 that provides videoconferencing functionality to various client devices. The system 100 includes a chat and video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a chat and video conference provider 110 may supply components to enable a private organization to host private internal video conferences or to connect its system to the chat and video conference provider 110 over a public network.

The system optionally also includes one or more authentication and authorization providers, e.g., authentication and authorization provider 115, which can provide authentication and authorization services to users of the client devices 140-160. Authentication and authorization provider 115 may authenticate users to the chat and video conference provider 110 and manage user authorization for the various services provided by chat and video conference provider 110. In this example, the authentication and authorization provider 115 is operated by a different entity than the chat and video conference provider 110, though in some examples, they may be the same entity.

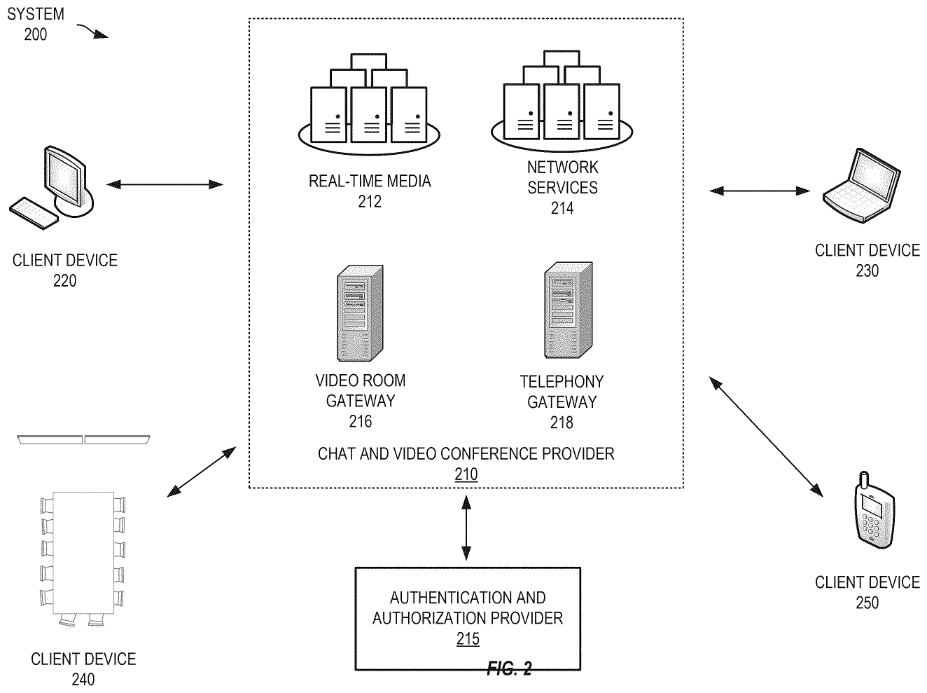

Chat and video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example chat and video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or a client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started, or the host may be required to specifically admit one or more of the users.

During the meeting, the participants may employ their client devices 140-180 to capture audio or video information and stream that information to the chat and video conference provider 110. They also receive audio or video information from the chat and video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communication devices that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user authentication information, meeting identifiers, meeting passwords or passcodes, etc. In examples that employ an authentication and authorization provider 115, a client device, e.g., client devices 140-160, may operate in conjunction with an authentication and authorization provider 115 to provide authentication and authorization information or other user information to the chat and video conference provider 110.

An authentication and authorization provider 115 may be any entity trusted by the chat and video conference provider 110 that can help authenticate a user to the chat and video conference provider 110 and authorize the user to access the services provided by the chat and video conference provider 110. For example, a trusted entity may be a server operated by a business or other organization with whom the user has created an account, including authentication and authorization information, such as an employer or trusted third-party. The user may sign into the authentication and authorization provider 115, such as by providing a username and password, to access their account information at the authentication and authorization provider 115. The account information includes information established and maintained at the authentication and authorization provider 115 that can be used to authenticate and facilitate authorization for a particular user, irrespective of the client device they may be using. An example of account information may be an email account established at the authentication and authorization provider 115 by the user and secured by a password or additional security features, such as single sign-on, hardware tokens, two-factor authentication, etc. However, such account information may be distinct from functionality such as email. For example, a health care provider may establish accounts for its patients. And while the related account information may have associated email accounts, the account information is distinct from those email accounts.

Thus, a user's account information relates to a secure, verified set of information that can be used to authenticate and provide authorization services for a particular user and should be accessible only by that user. By properly authenticating, the associated user may then verify themselves to other computing devices or services, such as the chat and video conference provider 110. The authentication and authorization provider 115 may require the explicit consent of the user before allowing the chat and video conference provider 110 to access the user's account information for authentication and authorization purposes.

Once the user is authenticated, the authentication and authorization provider 115 may provide the chat and video conference provider 110 with information about services the user is authorized to access. For instance, the authentication and authorization provider 115 may store information about user roles associated with the user. The user roles may include collections of services provided by the chat and video conference provider 110 that users assigned to those user roles are authorized to use. Alternatively, more or less granular approaches to user authorization may be used.

When the user accesses the chat and video conference provider 110 using a client device, the chat and video conference provider 110 communicates with the authentication and authorization provider 115 using information provided by the user to verify the user's account information. For example, the user may provide a username or cryptographic signature associated with an authentication and authorization provider 115. The authentication and authorization provider 115 then either confirms the information presented by the user or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide authentication information to authenticate the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide account information to the chat and video conference provider 110, even in cases where the user could authenticate and employs a client device capable of authenticating the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to chat and video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a chat and video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a chat and video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more authentication and authorization providers 215, which can authenticate various users to the chat and video conference provider 210 generally as described above with respect to FIG. 1.

In this example, the chat and video conference provider 210 employs multiple different servers (or groups of servers) to provide different examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O) as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting an authentication and authorization provider 215 to verify the provided credentials. Once the user's credentials have been accepted, and the user has consented, the network services servers 214 may perform administrative functionality, like updating user account information, if the user has account information stored with the chat and video conference provider 210, or scheduling a new meeting, by interacting with the network services servers 214. Authentication and authorization provider 215 may be used to determine which administrative functionality a given user may access according to assigned roles, permissions, groups, etc.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may select a user to remove and issue a command through a user interface on their client device. The command may be sent to a network services server 214, which may then disconnect the selected user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices' participation in meetings hosted by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio streams to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

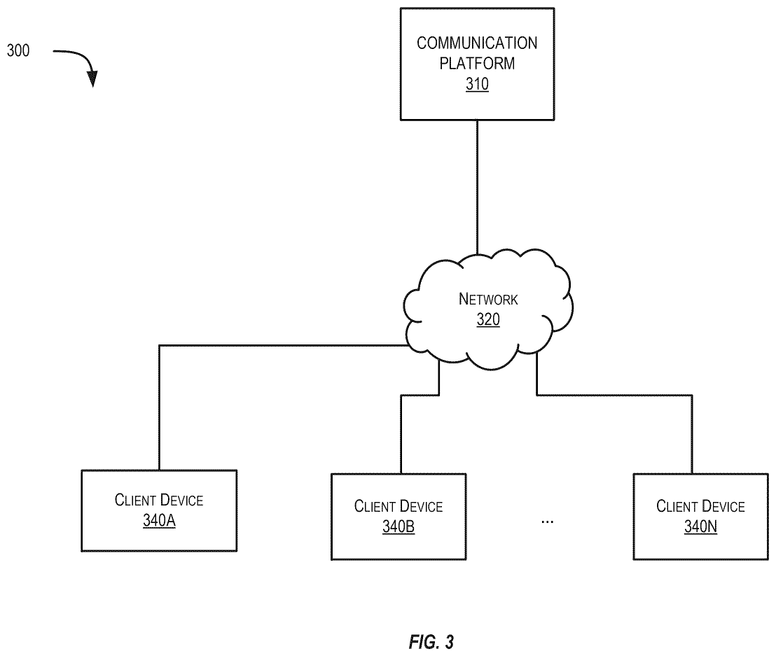

Referring now to FIG. 3, FIG. 3 shows an example system 300 for establishing a virtual communication session. In this example system 300, a communication platform 310 and a number of client device 340A-340N (which may be referred to herein individually as a client device 340 or collectively as the client devices 340) are connected via a network 320. The communication platform 310 can be any suitable communication platform, such as the chat and video conference provider 110 in FIG. 1 or the chat and video conference provider 210 in FIG. 2. The network 320 can be the internet or any suitable communications network or combination of communications network may be employed, including LANs (e.g., within a corporate private LAN), WANs, MANs, cellular network (e.g., 3G, 4G, 4G LTE, 5G, etc.), or any combination of these.

The client devices 340 can be any suitable computing or communications device. The client device 340 can be a client device (e.g., 140, 150, 160, or 170) in FIG. 1 or a client device (e.g., 220, 230, or 250) in FIG. 2. For example, client devices 340 may be desktop computers, laptop computers, tablets, smart phones having processors and computer-readable media, connected to the communication platform 310 using the internet or other suitable computer network. The client devices 340 have communication software installed to enable them to connect to the communication platform 310 for chats, video conferences, emails, and any other suitable communications. For example, during a chat session, a user associated a client device (e.g., client device 340A) can interact with other users associated with other client devices (e.g., client device 340B-340N) via the communication platform 310 by sending and receiving chat messages, and reacting to received chat messages.

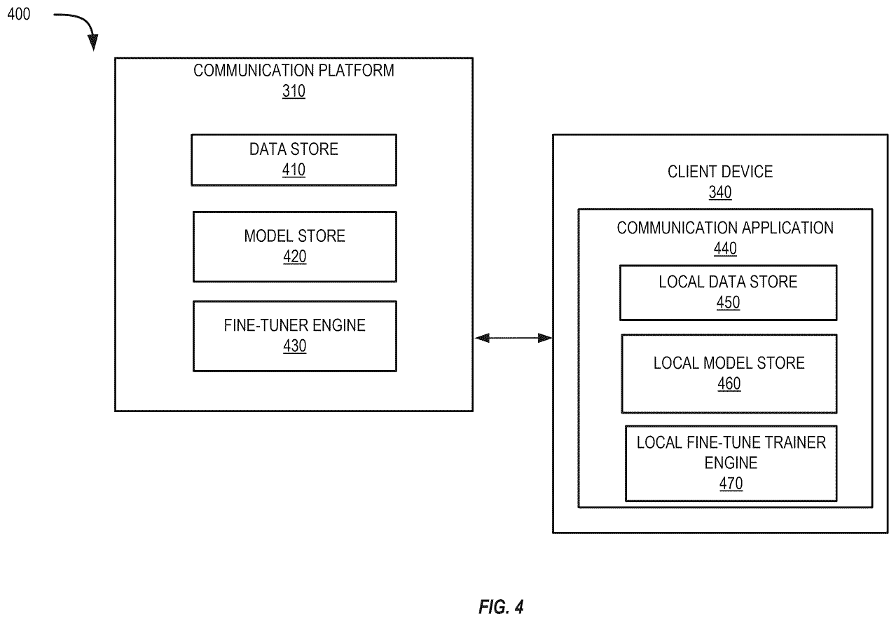

Referring now to FIG. 4, FIG. 4 shows an example system that is configured to fine-tune an LLM. The communication platform 310 is in network communication with a client device 340. The communication platform 310 includes a data store 410, a model store 420, and a fine-tuner engine 430.

The data store 410 stores historical communication data associated with different client devices 340, among other types of data. The historical communication data can include video conference recordings, video conference transcripts, chat messages, emails, and other types of communication data. The historical communication data can be used as inputs to an LLM for generating outputs for certain generative tasks in certain languages. The outputs from the LLM based on the inputs can also be stored in the data store 410. The data store 410 can also store fine-tuning inputs, fine-tuning outputs, and other data used to fine-tune one or more LLMs, as will be described below.

The model store 420 includes different AI/ML models, including LLMs for various generative tasks in various languages. In some examples, the model store 420 stores the LLMs on the communication platform 310. In some examples, the model store 420 includes APIs for accessing various LLMs from different parts of the communication platform 310 or from a third-party platform (not shown). The LLMs can include regular LLMs, which can have hundreds of billions or even trillions of parameters. The LLMs can also include smaller versions of LLMs, which can have a few million to a few billion parameters. Examples of LLMs include GPT models of different versions, autoregressive LLMs (e.g., Large Language Model Meta A (LLaMA)), transformer-based autoregressive LLMs (e.g., BigScience Large Open-science Open-access Multilingual Language Models (BLOOMs)), Zephyr, MISTRAL, causal decoder-only models (e.g., Falcon), MosaicML Pretrained Transformer (MPT) models, Bidirectional Encoder Representations from Transformers (BERT) models, or Text-to-Text Transformer (T5) models. Especially, some examples of small LLMs can include DistiBERT, BERT Mini, BERT Small, BERT Medium, BERT Tiny, MobileBERT, T5-small, Orca 2, GPT-Neo, GPT-J, all of which are scaled-down versions of regular LLMs. The model store 420 can also include translation models for translating certain data from one language to another and label generation models for generating human-quality labels in certain input data.

A user may select a small version of an LLM for certain generative tasks in a target language, which may be a non-English language. The small version of the LLM is a target pre-trained LLM. However, the target pre-trained LLM may not have satisfactory performance in target language. The user may request the communication platform 310 to fine-tune the target pre-trained LLM.

The fine-tuner engine 430 is configured to fine-tune the target pre-trained LLM for a generative task. The fine-tuner engine 430 can include an AI/ML model trained to fine-tune a pre-trained LLM or other trained AI/ML models, which can be called a fine-tuner model. The fine-tuner model can be based on an AI/ML model selected from the model store 420. The generative task can be summarizing, which is to generate a summary of an input (e.g., transcript, chat messages, etc.). The generative task can be paraphrasing, which is to generate a restatement an input in different words without changing the meaning. The generative task can be question-answer generation, which is to generate questions and answers based on an input (e.g., reports, articles, studies, webpage contents, etc.). Alternatively, the generative task can be other suitable tasks.

In some examples, the fine-tuner engine 430 fine-tunes a target pre-trained LLM by using joint input data. For example, the fine-tuner engine 430 can access a fine-tuning input in the target language. The fine-tuner engine 430 can enable a translation model, for example from the model store 420 on the communication platform 310, to translate the fine-tuning input in the target language to obtain a fine-tuning input in a reference language. The reference language is usually English. The fine-tuner engine 430 can also access labeled data from the fine-tuning input in the target language. The labeled data can be generated by human annotation. Alternatively, or additionally, the fine-tuner engine 430 can implement a label generation model to generate human quality labels for the fine-tuning input in the target language to obtain labeled data. The labeled data can be considered as ground truth fine-tuning output in the target language. The fine-tuner engine 430 can use the pre-trained LLM to generate an interim output in the target language based on the fine-tuning input in the target language and the fine-tuning input in the reference language. The fine-tuner engine 430 then minimizes a loss function (e.g., cross-entropy loss) associated with the interim output in the target language and the ground truth fine-tuning output, by adjusting or optimizing certain weights used in the target pre-trained LLM. The fine-tuner engine 430 then updates the pre-trained LLM with optimized weights to provide a fine-tuned LLM.

Alternatively, or additionally, the fine-tuner engine 430 can fine-tune the target pre-trained LLM by using joint output data. For example, the fine-tuner engine 430 uses a frozen model to obtain an output in the target language based on the fine-tuning input in the target language, and obtain an output in the reference language based on the fine-tuning input in the reference language. The frozen model can be the pre-trained LLM or another LLM that is considered to have better performance in the target language and/or the reference language, than the pre-trained LLM does. In some examples, the frozen model is a large LLM with hundreds of billions or even trillions of parameters, compared to the pre-trained LLM which is generally a small LLM with only up to a few billion parameters.

The fine-tuner engine 430 then uses the pre-trained LLM to generate an interim output in the target language based on the fine-tuning input in the reference language, the output in the reference language generated by the frozen model, and the output in the reference language generated by the frozen model. The fine-tuner engine 430 can minimize a loss function (e.g., cross-entropy loss) associated with the interim output in the reference language and the ground truth fine-tuning output, by adjusting or optimizing certain weights used in the pre-trained LLM. The fine-tuner engine 430 then updates the pre-trained LLM with the optimized weights to provide a fine-tuned LLM.

In some examples, a generative task in a target language is requested either automatically or on demand. The communication platform 310 can automatically fine-tune a pre-trained LLM for the target language prior to performing the generative task in the target language. The input used for fine-tuning can be pre-stored in the data store 410. Alternatively, or additionally, the input for a generative task each time can be used to fine-tune the pre-trained LLM for improved performance next time.

The communication application 440 installed on the client device 340 can include a local data store 450, a local model store 460, and a local fine-tuner engine 470. The local data store 450 can store local communication data, fine-tuning input data, labeled data, among other data related to a local user. The local model store 460 can store one or more LLMs, translation models, or label generation models. The local fine-tuner engine 470 can be configured to fine-tune pre-trained LLMs, similar to the fine-tuner engine 430 as described above. The communication application 440 can also include a graphical user interface (GUI) for virtual communication, such as video conferences, chats, phone calls, or emails. The GUI can also provide a button for certain generative tasks. For example, one button in a GUI of a recorded video conference in Italian can be associated with summary generation. A user can activate the button, triggering a pre-trained LLM to generate a summary of the video conference in Italian based on the transcript of the video conference in Italian. Alternatively, the generative tasks are performed automatically, and the GUI can provide a button to access automatically generated content, for example the summary of the video conference in Italian.

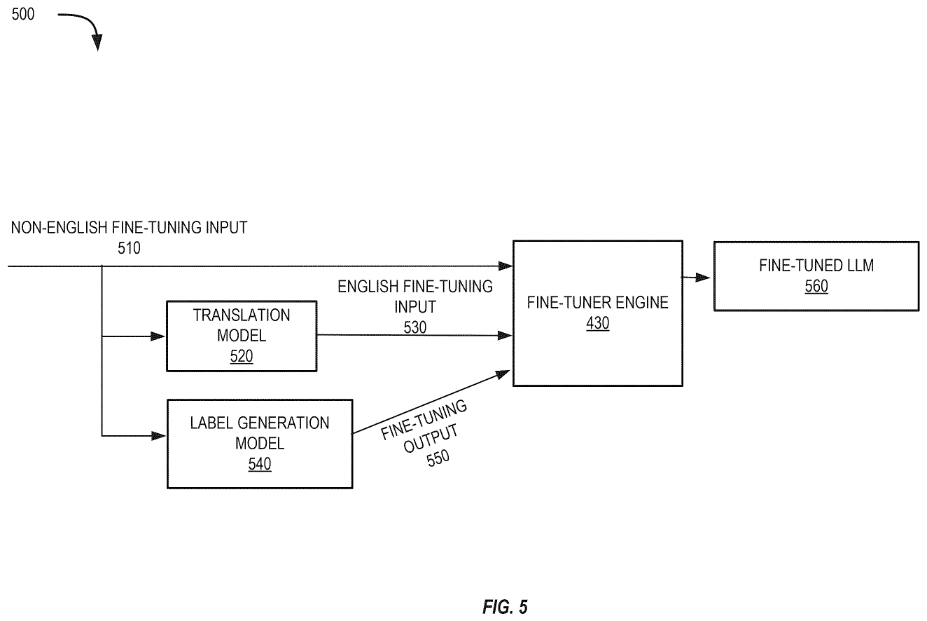

FIG. 5 shows an example diagram 500 of fine-tuning a pre-trained LLM. In FIG. 5, a pre-trained LLM is fine-tuned for performing generative tasks in a specific non-English language based on joint input data. The non-English fine-tuning input 510 can be stored in the data store 410 on the communication platform 310. The fine-tuner engine 430 retrieves the non-English fine-tuning input 510 stored in the data store 410. The fine-tuner engine 430 executes a translation model 520 to translate the non-English fine-tuning input 510 to English fine-tuning input 530. The fine-tuner engine 430 also executes a label generation model 540 to generate human-quality labels as fine-tuning output 550 based on the non-English fine-tuning input 510. The fine-tuner engine 430 then fine-tunes the pre-trained LLM based on the non-English fine-tuning input 510, the English fine-tuning input 530, and the fine-tuning output 550, generally as described in FIG. 4. The fine-tuner engine 430 provides a fine-tuned LLM 560, whose generative performance in the non-English language can be improved.

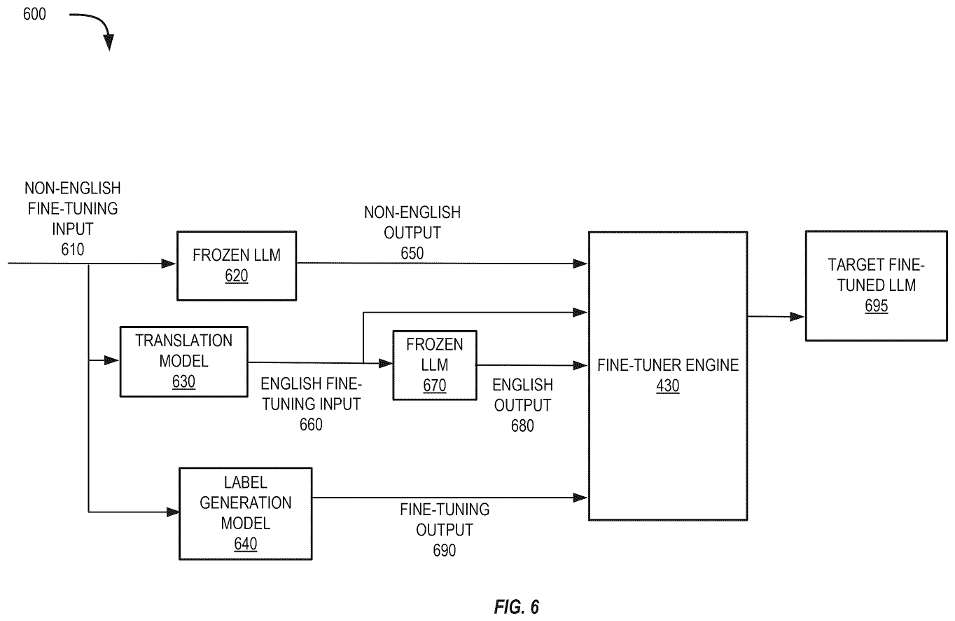

FIG. 6 shows another example diagram 600 of fine-tuning a pre-trained LLM. In FIG. 6, a pre-trained LLM is fine-tuned for performing generative tasks in a specific non-English language based on joint output data. The fine-tuner engine 430 retrieves the non-English fine-tuning input 610 stored in the data store 410. The fine-tuner engine 430 executes a frozen LLM 620 to generate a non-English output 650 based on the non-English fine-tuning input. The frozen LLM 620 can be the pre-trained LLM or a different LLM which can provide better results in both the non-English language and English. Meanwhile, the fine-tuner engine 430 also executes a translation model 630 to translate the non-English fine-tuning input 610 to English fine-tuning input 660. The fine-tuner engine 430 then executes a frozen LLM 670 to generate an English output 680 based on the English fine-tuning input 660. The frozen LLM 670 can be the same model as the frozen LLM 620. Alternatively, the frozen LLM 620 and the frozen LLM 670 can be different models. Similar to the example diagram 500, in example diagram 600, the fine-tuner engine 430 also executes a label generation model 640 to generate human-quality labels as fine-tuning output 690. The fine-tuner engine 430 then fine-tunes the pre-trained LLM based on the non-English output 650, the English fine-tuning input 660, the English output 680, and the fine-tuning output 690. The fine-tuner engine 430 provides a fine-tuned LLM 695, whose generative performance in the non-English language can be improved.

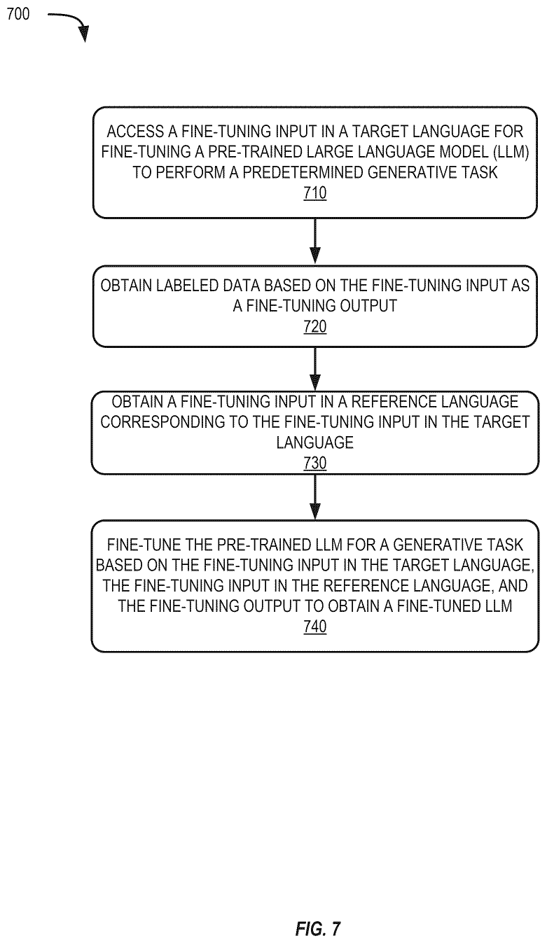

Referring now to FIG. 7, FIG. 7 shows an example process 700 for fine-tuning a pre-trained LLM. The example process 700 will be discussed with respect to the system 400 shown in FIG. 4 and the example diagram 500 in FIG. 5; however, any suitable system for fine-tuning LLMs can be used. FIG. 7 is directed to fine-tuning a pre-trained LLM based on joint input data.

At block 710, a communication platform 310 accesses a fine-tuning input in a target language for a pre-trained LLM. The fine-tuner engine 430 on the communication platform 310 can receive the fine-tuning input in the target language for fine-tuning a pre-trained LLM. The fine-tuning input can be historical communication data in the target language stored in the data store 410 of the communication platform 310. Alternatively, current communication data in the target language that is to be processed by the pre-trained LLM for a generative task can be first used to fine-tune the pre-trained LLM. The pre-trained LLM can be a small LLM with a few million or a few billion parameters, or a reduced version of a regular LLM. Alternatively, or additionally, the pre-trained LLM can be a full-sized LLM with hundreds of billions or even trillions of parameters.

At block 720, the communication platform 310 obtains labeled data based on the fine-tuning input as a fine-tuning output. In some examples, a human annotator labels the fine-tuning input with labels to create labeled data as fine-tuning output. Alternatively, or additionally, the communication platform 310 or the fine-tuner engine 430 can implement a label generation model 540 to generate human quality labels for the fine-tuning input to provide the labeled data. The labeled data can be considered as the ground truth fine-tuning output for the fine-tuner engine 430 to fine-tune the pre-trained LLM.

At block 730, the communication platform 310 obtains a fine-tuning input in a reference language corresponding to the fine-tuning input in the target language. In some examples, a user provides the fine-tuning input in the reference language, which can be manually translated from the fine-tuning input in the target language. Alternatively, or additionally, the communication platform 310 or the fine-tuner engine 430 on the communication platform 310 can implement a translation model to translate the fine-tuning input in the target language to the reference language. The reference language can be English, and the target language is a non-English language. The fine-tuner engine 430 receives the fine-tuning input in the reference language for fine-tuning the pre-trained LLM.

At block 740, the communication platform 310 fine-tunes the pre-trained LLM for a generative task based on the fine-tuning input in the target language, the fine-tuning input in the reference language, and the fine-tuning output to obtain a fine-tuned LLM. The fine-tuner engine 430 can fine-tune the pre-trained LLM based on the fine-tuning input in the target language, the fine-tuning input in the reference language, and the fine-tuning output, generally as described in FIG. 4 and FIG. 5. For example, the fine-tuner engine 430 can use the pre-trained LLM to generate an interim output in the target language based on the fine-tuning input in the target language and the fine-tuning input in the reference language. The fine-tuner engine 430 then minimizes a cross entropy loss associated with the interim output in the target language and the fine-tuning output to obtain one or more optimized weights for the pre-trained LLM. The pre-trained LLM can be updated with the one or more optimized weights to become the fine-tuned pre-trained LLM.

The example process 700 illustrates a method for fine-tuning an LLM based on joint input data, including the fine-tuning input in the reference language and the fine-tuning input in the target language. However, not every step in the example process 700 may be needed, some other steps may be added, or some steps in the example process 700 may be performed in different orders. The process 700 can be performed iteratively with different fine-tuning inputs to fine-tune the pre-trained LLM repeatedly, for example until the performance of the fine-tuned LLM reaches an acceptable level. The example process 700 is performed by a communication platform 310. Alternatively, the example process 700 can be performed by a communication application 440 installed on a client device 340 and provided by the communication platform 310.

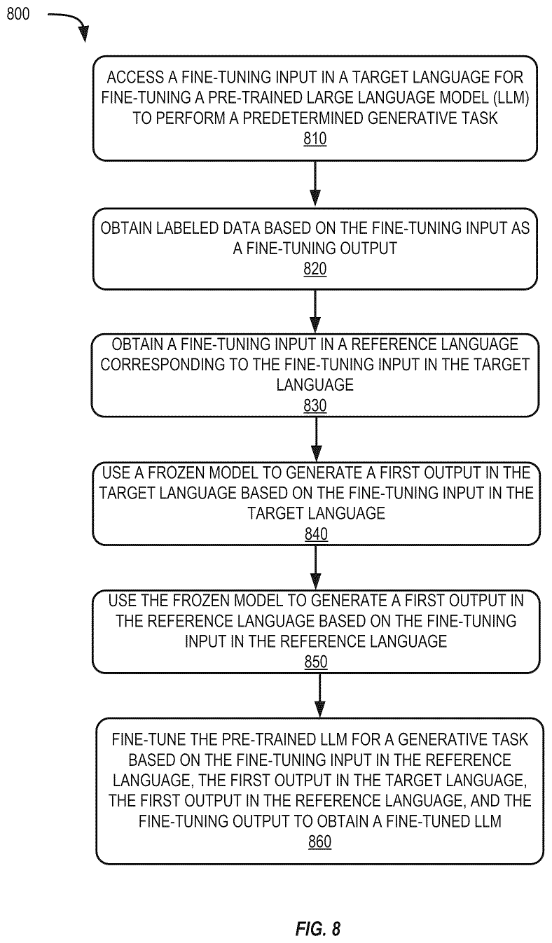

Referring now to FIG. 8, FIG. 8 shows an example process 800 for fine-tuning a pre-trained LLM. The example process 800 will be discussed with respect to the system 400 shown in FIG. 4 and the example diagram 600 in FIG. 6; however, any suitable system for fine-tuning LLMs can be used. FIG. 8 is directed to fine-tuning a pre-trained LLM based on joint output data.

At block 810, a communication platform 310 accesses a fine-tuning input in a target language for fine-tuning a pre-trained LLM. At block 820, the communication platform 310 obtains labeled data based on the fine-tuning input as a fine-tuning output. At block 830, the communication platform 310 obtains a fine-tuning input in a reference language corresponding to the fine-tuning input in the target language. Blocks 810-830 can be substantially the same as blocks 710-730, generally as described in FIG. 7.

At block 840, the communication platform 310 uses a frozen model to generate a first output in the target language based on the fine-tuning input in the target language. The communication platform 310 or the fine-tuner engine 430 on the communication platform 310 can execute a frozen model to generate a first output in the target language based on the fine-tuning input in the target language, generally as described in FIG. 4 and FIG. 6. The frozen model can be the pre-trained LLM or a different LLM. The different LLM is generally an LLM that performs better in the target language and/or the reference language.

At block 850, the communication platform 310 uses the frozen model to generate a first output in the reference language based on the fine-tuning input in the reference language. The frozen model at block 850 can be the same frozen model as used at block 850. Alternatively, the frozen model at block 850 can be a different frozen model from the one used at block 850. The frozen model can generate a first output in the reference language based on the fine-tuning input in the reference language.

At block 860, the communication platform 310 fine-tunes the pre-trained LLM for a generative task based on the fine-tuning input in the reference language, the first output in the target language, the first output in the reference language, and the fine-tuning output to obtain a fine-tuned LLM. The fine-tuner engine 430 on the communication platform 310 can fine-tune the pre-trained LLM based on the fine-tuning input in the reference language, the first output in the target language, the first output in the reference language, and the fine-tuning output, generally as described in FIG. 4 and FIG. 6. For example, the fine-tuner engine 430 uses the pre-trained LLM to generate a second output in the target language based on the fine-tuning input in the reference language, the first output in the target language, and the first output in the reference language. The fine-tuner engine 430 then minimizes a cross entropy loss associated with the second output in the target language and the fine-tuning output to obtain one or more optimized weights for the pre-trained LLM. The pre-trained LLM can be updated with the one or more optimized weights to become the fine-tuned pre-trained LLM.

The example process 800 illustrates a method for fine-tuning an LLM based on joint output data, for example the first output in the target language, the first output in the reference language, and the fine-tuning output in the target language. However, not every step in the example process 800 may be needed, some other steps may be added, or some steps in the example process 800 may be performed in different orders. The process 800 can be performed iteratively by providing different fine-tuning inputs to generate different outputs for fine-tuning the pre-trained LLM repeatedly, for example until the performance of the fine-tuned LLM reaches an acceptable level. The example process 800 is performed by a communication platform 310. Alternatively, the example process 800 can be performed by a communication application 440 installed on a client device 340 and provided by the communication platform 310.

The example process 700 can be used for scenarios where the input (or fine-tuning input) of the pre-trained LLM is of smaller size than the output (or fine-tuning output), or in general of small size. For example, the input or the fine-tuning input is a paragraph or a few sentences. In contrast, the example process 800 can be used for scenarios where the output (or fine-tuning output) is of smaller size than the input (or fine-tuning input), or where the input (or fine-tuning input) is in general of large size. For example, the input or fine-tuning input is a transcript of a video conference, which can be 30 minutes or an hour long. The output or fine-tuning output can be a summary of the transcript, which can be a few sentences long. In some examples, the example process 700 and the example process 800 are both used to fine-tune a pre-trained LLM, in sequence, alternately, or repeatedly.

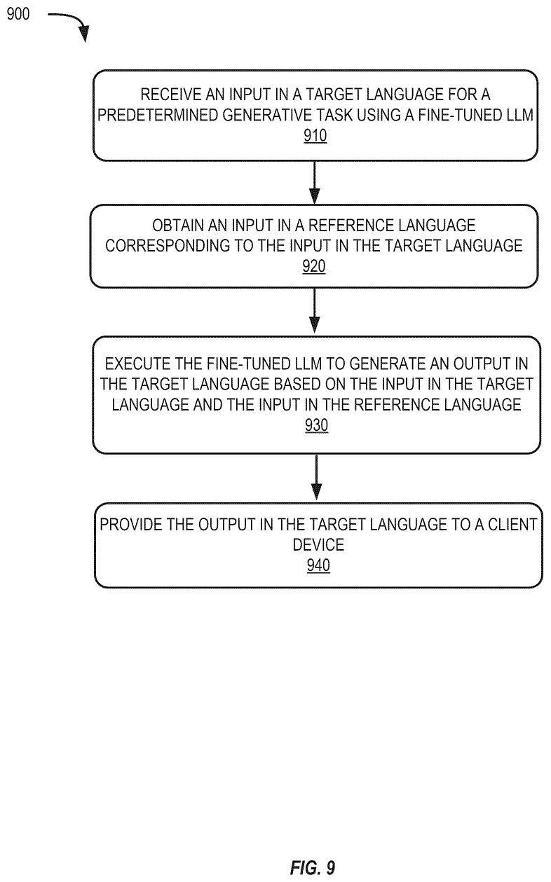

Referring now to FIG. 9, FIG. 9 shows an example process 900 for generating an output using a fine-tuned LLM in FIG. 7. At block 910, a communication platform 310 receives an input in a target language for a predetermined generative task using a fine-tuned LLM. The input can be historical or current communication data associated with a user and generated in a communication session established on the communication platform 310. The target language can be the target language for which the fine-tuned LLM is fine-tuned, for example as in FIG. 7. In some examples, the target language is a non-English language. Examples of the input can include a meeting transcript, chat messages, and emails. The predefined generative task can be the same generative task used for fine-tuning the LLM as in FIG. 7. Alternatively, or additionally, the predefined generative task can be a different generative task different from the one used for fine-tuning the LLM.

At block 920, the communication platform 310 obtains an input in a reference language corresponding to the input in the target language. In some examples, the communication platform 310 implements a translation model to translate the input in the target language to obtain the input in the reference language. In some examples, the input in the reference language corresponding to the target language is provided by human translation. The reference language can be the reference language used for fine-tuning the LLM in FIG. 7. In some examples, the reference language is English.

At block 930, the communication platform 310 executes the fine-tuned LLM to generate an output in the target language based on the input in the targe language and the input in the reference language for the predetermined generative task. The fine-tuned LLM can be stored in the model store 420 after fine-tuning, and the communication platform 310 retrieves the fine-tuned LLM from the data store 410. Alternatively, the fine-tuned LLM can be executed right after the fine-tuning in FIG. 7.

At block 940, the communication platform 310 provides the output in the target language to a client device 340. The output in the target language can be provided to a client device 340 associated with the user, whom the input in the target language at block 910 is associated with. The output in the target language can be displayed on a GUI of the client device 340. Alternatively, the output in the target language can be displayed in a GUI of the client device 340 in response to a user activating a GUI element, for example by clicking or touching a corresponding button. For example, the input is a paragraph of text in Italian provided by a user, and the output is a paraphrase of the paragraph in Italian. The paraphrase of the paragraph can be displayed in a hovering window when a user moves the cursor to the body of the email.

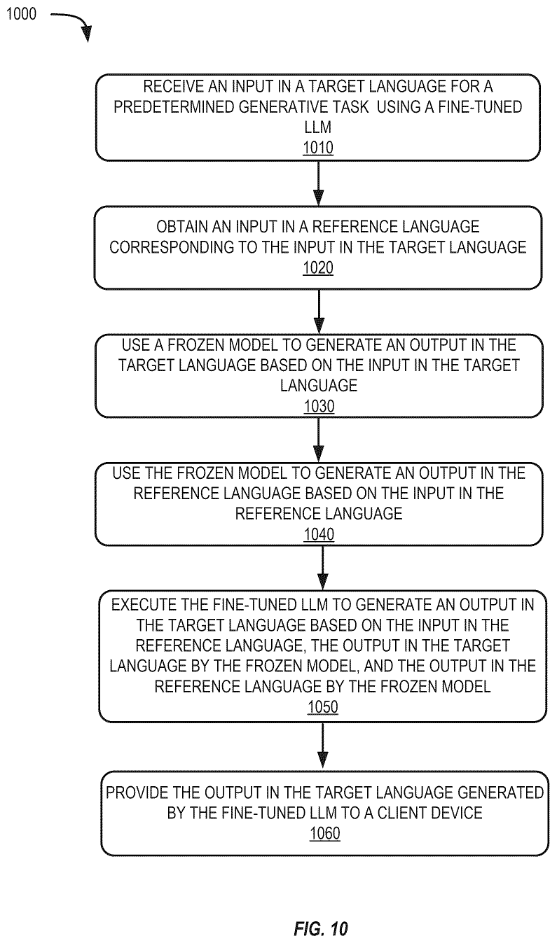

Referring now to FIG. 10, FIG. 10 shows an example process 1000 for generating an output using a fine-tuned LLM in FIG. 8. At block 1010, a communication platform 310 receives an input in a target language for a predetermined generative task using a fine-tuned LLM. At block 1020, the communication platform 310 obtains an input in a reference language corresponding to the input in the target language. Blocks 1010 and 1020 can be substantially the same as blocks 910 and 920, generally as described in FIG. 9.

At block 1030, the communication platform 310 uses a frozen model to generate an output in the target language for the predetermined generative task based on the input in the target language. The frozen model can be the pre-trained LLM prior to fine-tuning or a different LLM. The different LLM is generally an LLM that performs better in the target language and/or the reference language. The frozen model at block 1030 can be the same frozen model used for fine-tuning the LLM as described in FIG. 8. Alternatively, or additionally, the frozen model can be different from the one used for fine-tuning the LLM as described in FIG. 8. The communication platform 310 executes the frozen model to generate an output in the target language based on the input in the target language for a predefined generative task.

At block 1040, the communication platform 310 uses the frozen model to generate an output in the reference language for the predetermined generative task based on the input in the reference language. The communication platform 310 executes the frozen model to generate an output in the reference language based on the input in the reference language for the same predetermined generative task, as in block 1030. The frozen model at block 1040 can be the same frozen model as used at block 1030. Alternatively, the frozen model at block 1040 can be a different frozen model from the one used at block 1030.

At block 1050, the communication platform 310 executes the fine-tuned LLM to generate an output in the target language for the predetermined generative task based on the input in the reference language, the output in the target language by the frozen model, and the output in the reference language by the frozen model. The fine-tuned LLM can be stored in the model store 420 after fine-tuning, and the communication platform 310 retrieves the fine-tuned LLM from the data store 410. Alternatively, the fine-tuned LLM can be executed right after the fine-tuning.

At block 1060, the communication platform 310 provides the output in the target language generated by the fine-tuned LLM to a client device 340. The output in the target language can be provided to a client device 340 associated with the user, whom the input in the target language is associated with. The output in the target language can be displayed on a GUI of the client device 340. Alternatively, the output in the target language can be displayed in a GUI of the client device 340 in response to a user activating a GUI element, for example by clicking or touching a corresponding button. For example, the input is a meeting transcript provided by a user, and the output is a summary in Italian of the meeting. The summary of the meeting can be displayed next to a meeting recording in a GUI.

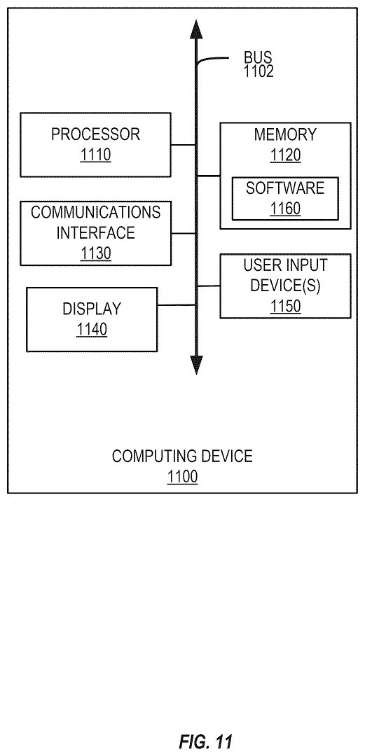

Referring now to FIG. 11, FIG. 11 shows an example computing device 1100 suitable for use in example systems or methods for fine-tuning a pre-trained LLM or using a fine-tuned LLM to generate an output according to this disclosure. The example computing device 1100 includes a processor 1110 which is in communication with the memory 1120 and other components of the computing device 1100 using one or more communications buses 1102. The processor 1110 is configured to execute processor-executable instructions stored in the memory 1120 to perform one or more methods for fine-tuning a pre-trained LLM or using a fine-tuned LLM to generate an output according to different examples, such as part or all of the example processes 700,800, 900, and 1000 described above with respect to FIGS. 7,8, 9, and 10. In some embodiments, the computing device may include software 1160 for executing one or more methods described herein, such as for example, one or more steps of processes 700,800, 900, and 1000. The computing device 1100, in this example, also includes one or more user input devices 1150, such as a keyboard, mouse, touchscreen, microphone, etc., to accept user input. The computing device 1100 also includes a display 1140 to provide visual output to a user.

The computing device 1100 also includes a communications interface 1130. In some examples, the communications interface 1130 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random-access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
accessing a fine-tuning input in a target language for fine-tuning a pre-trained large language model (LLM);
obtaining labeled data based on the fine-tuning input in the target language as a fine-tuning output;
obtaining a fine-tuning input in a reference language corresponding to the fine-tuning input in the target language; and
fine-tuning the pre-trained LLM for a generative task based on the fine-tuning input in the target language, the fine-tuning input in the reference language, and the fine-tuning output to obtain a first fine-tuned LLM.

2. The method of claim 1, wherein the reference language is English, and the target language is not English.

3. The method of claim 1, wherein the labeled data is provided by a human annotator.

4. The method of claim 1, further comprising using a generative model to generate the labeled data based on the fine-tuning input in the target language.

5. The method of claim 1, further comprising using a translation model to generate the fine-tuning input in the reference language based on the fine-tuning input in the target language.

6. The method of claim 1, wherein fine-tuning the pre-trained LLM for a generative task comprises:
using the pre-trained LLM to generate an interim output in the target language for the generative task based on the fine-tuning input in the target language and the fine-tuning input in the reference language;
minimizing a cross entropy loss associated with the interim output in the target language and the fine-tuning output to obtain one or more optimized weights for the pre-trained LLM; and
providing the first fine-tuned LLM comprising the one or more optimized weights.

7. The method of claim 1, further comprising:
receiving an input in the target language;
obtaining an input in the reference language corresponding to the input in the target language; and
implementing the first fine-tuned LLM to generate an output in the target language for the generative task based on the input in the target language and the input in the reference language.

8. The method of claim 1, further comprising:
using a frozen model to generate a first output in the target language for the generative task based on the fine-tuning input in the target language;
using the frozen model to generate a first output in the reference language for the generative task based on the fine-tuning input in the reference language; and
fine-tuning the pre-trained LLM for the generative task based on the fine-tuning input in the reference language, the first output in the target language, the first output in the reference language, and the fine-tuning output to obtain a second fine-tuned LLM.

9. The method of claim 8, wherein fine-tuning the pre-trained LLM comprises:
using the pre-trained LLM to obtain a second output in the target language for the generative task based on the fine-tuning input in the reference language, the first output in the target language, and the first output in the reference language; and
determining one or more optimized weights in the pre-trained LLM by minimizing a cross-entry loss associated with the second output in the target language and the fine-tuning output to obtain the second fine-tuned LLM.

10. The method of claim 8, further comprising:
receiving an input in the target language;
using the frozen model to generate a second output in the target language for the generative task based on the input in the target language;
obtaining an input in the reference language corresponding to the input in the target language;
using the frozen model to generate a second output in the reference language for the generative task based on the input in the reference language; and
implementing the second fine-tuned LLM to generate an output in the target language for the generative task based on the input in the reference language, the second output in the reference language, and the second output in the target language.

11. The method of claim 8, wherein the frozen model comprises the pre-trained LLM or a different LLM.

12. A system comprising:
a communications interface;
a non-transitory computer-readable medium; and
one or more processors communicatively coupled to the communications interface and the non-transitory computer-readable medium, the one or more processors configured to execute processor-executable instructions stored in the non-transitory computer-readable medium to:
access a fine-tuning input in a target language for fine-tuning a pre-trained large language model (LLM);
obtain labeled data based on the fine-tuning input as a fine-tuning output;
obtain a fine-tuning input in a reference language corresponding to the fine-tuning input in the target language; and
fine-tune the pre-trained LLM for a generative task based on the fine-tuning input in the target language, the fine-tuning input in the reference language, and the fine-tuning output to obtain a first fine-tuned LLM.

13. The system of claim 12, wherein the reference language is English, and the target language is a non-English language.

14. The system of claim 12, wherein the one or more processors are configured to execute further processor-executable instructions stored in the non-transitory computer-readable medium to:
use a generative model to generate the labeled data based on the fine-tuning input in the target language.

15. The system of claim 12, wherein the one or more processors are configured to execute further processor-executable instructions stored in the non-transitory computer-readable medium to:
receive an input in the target language;
obtain an input in the reference language corresponding to the input in the target language; and
use the first fine-tuned LLM to generate an output in the target language for the generative task based on the input in the target language and the input in the reference language.

16. The system of claim 12, wherein the one or more processors are configured to execute further processor-executable instructions stored in the non-transitory computer-readable medium to:
use a frozen model to generate a first output in the target language for the generative task based on the fine-tuning input in the target language;
use the frozen model to generate a first output in the reference language for the generative task based on the fine-tuning input in the reference language; and
fine-tune the pre-trained LLM for the generative task based on the fine-tuning input in the reference language, the first output in the target language, the first output in the reference language, and the fine-tuning output to obtain a second fine-tuned LLM.

17. The system of claim 16, wherein the one or more processors are configured to execute further processor-executable instructions stored in the non-transitory computer-readable medium to:
receive an input in the target language;
use the frozen model to generate a second output in the target language for the generative task based on the input in the target language;
obtain an input in the reference language corresponding to the input in the target language;
use the frozen model to generate a second output in the reference language for the generative task based on the input in the reference language; and
implement the second fine-tuned LLM to generate an output in the target language for the generative task based on the input in the reference language, the second output in the reference language, and the second output in the target language.

18. A non-transitory computer-readable medium comprising processor-executable instructions configured to cause one or more processors to:
access a fine-tuning input in a target language for a pre-trained large language model (LLM);
obtain labeled data based on the fine-tuning input as a fine-tuning output;
obtain a fine-tuning input in a reference language corresponding to the fine-tuning input in the target language; and
fine-tune the pre-trained LLM for a generative task based on the fine-tuning input in the target language, the fine-tuning input in the reference language, and the fine-tuning output to obtain a first fine-tuned LLM.

19. The non-transitory computer-readable medium of claim 18, wherein fine-tuning the pre-trained LLM for a generative task comprises:
using the pre-trained LLM to obtain an interim output in the target language for the generative task based on the fine-tuning input in the target language and the fine-tuning input in the reference language; and
adjusting one or more weights in the pre-trained LLM based on the interim output in the target language and the fine-tuning output to obtain the first fine-tuned LLM.

20. The non-transitory computer-readable medium of claim 18, further comprising processor-executable instructions configured to cause one or more processors to:
use a frozen model to generate a first output in the target language for the generative task based on the fine-tuning input in the target language;
use the frozen model to generate a first output in the reference language for the generative task based on the fine-tuning input in the reference language; and
fine-tune the pre-trained LLM for the generative task based on the fine-tuning input in the reference language, the first output in the target language, the first output in the reference language, and the fine-tuning output to obtain a second fine-tuned LLM.
